(19) United States
(12) Patent Application Publication
(10) Pub. No.: US 2005/0162513 A1
(43) Pub. Date: Jul. 28, 2005

(54) Vehicle mounted navigation and incident recording device and method of operating

(75) Inventor: David Chan, North Salem, NY (US)

Correspondence Address: David Chan, 11 Westview Ave, N. Salem, NY, 10560, US

(73) Assignee: Advanced Future Technologies, Inc., North Salem, NY (US)

(21) Appl. No.: 10/988,885

(22) Filed: Nov. 16, 2004

Related U.S. Application Data
(63) Continuation-in-part of application No. 09/352,661, filed on Jul. 7, 1999, now abandoned.

(51) Int. Cl. H04N 9/47

(52) U.S. Cl. 348/118; 701/301

(57) ABSTRACT

A vehicle mounted, navigation device is disclosed. This invention combines a global position system (GPS) with an image capturing system into a portable device that can be optimally mounted within a vehicle. It can be used for land, air and sea vehicles. The image capturing system detects and interprets visual information to provide the vehicle operator with appropriate navigational guidance assistance and to alert operator of potentially hazardous conditions. Additionally, the device has the capability to store consecutive frames of detected, visual information so as to enable the device to be used for accident aftermath analysis and the documentation of an event or scene.

### CROSS-REFERENCE TO RELATED APPLICATION

This application is a continuation-in-part of U.S. application Ser. No. 09/352,661 filed on Jul. 7, 1999 with the U.S. Patent and Trademark Office. It also references teaching published in U.S. Pat. No. 5,899,956, issued May 4, 1999, by the same inventor.

### BACKGROUND OF THE INVENTION

1. Field of the Invention

This invention generally relates to vehicle-mounted, navigational guidance, image capturing and incident recording systems, and the means for improving their portability and usability. More particularly, this invention relates to devices capable of preserving visual scenes and detecting and interpreting visual information and providing alert to operator.

2. Description of the Related Art

There exist many types of vehicular navigational systems. The most sophisticated of these utilize local-area, digitized-road-map systems with video monitors which display a map portion of interest and a cursor that indicates the position of the driver's vehicle within the map portion of interest. The position of the vehicle is typically determined by using either a combination of a wheel-sensor odometer and a compass or the reception of electric signals from global positioning system (GPS) satellites. Using such a digitized map, the driver can locate departure and destination points on the map, and then visually follow the displayed map as the driver travels towards the desired destination point. During this travel, the portion of the map that is displayed is periodically adjusted to keep the cursor representing the driver's current position within the displayed map portion.

Several recent U.S. patents have been directed towards inventions to provide such navigation aids or to improve upon the various components of existing systems. For example, U.S. Pat. No. 5,552,990 discloses an improved vehicle position detecting apparatus that utilizes tire rotation and bearing sensors, along with techniques for compensating for road map errors, to compute the current position of the vehicle.

U.S. Pat. No. 5,652,706 discloses a vehicle navigation system that utilizes global positioning system (GPS) data along with sensors for monitoring tire rotation to determine the current position of the vehicle. This system includes a computer with an arithmetic section that, in the event the driver deviates from an initially identified optimum route, researches from stored, local area map data the shortest distance route back to the optimum route, with preference being given to those routes which avoid the driver having to make a U-turn. This system also includes an optional vocal control section that can provide voice guidance for the driver.

U.S. Pat. No. 5,642,106 discloses a visual incremental turn detector. This patent suggests that such a camera might be combined with an odometer and a CD-ROM device, for storing digitized video information obtained by driving an associated vehicle over a known course, in order to allow the subsequent determination of the present position of an automobile traveling along this same course. These elements are then described as being combinable with a computer and a video monitor or audio speaker to communicate navigation instructions to the driver.

U.S. Pat. No. 5,544,060 discloses a vehicle navigation system that sequentially outputs updated path information, based on a calculated optimal path, in accordance with the determined present position of the vehicle. This determination is described as being made by utilizing an axle sensor and a geomagnetic (or bearing) sensor. The path information is given by a microprocessor-generated videographical directional indicator that displays turn icons, along with pertinent road names and indications of the distance to be traveled before making the next scheduled turn. Similarly, U.S. Pat. No. 5,654,892 describes the improvement that consists of allowing for the display of more complex icons that indicate various road anomalies along with turn directions.

U.S. Pat. No. 5,646,856 describes a vehicle navigation system including means for storing data representing a route to be followed; means for detecting an actual position of and the actual path traveled by the vehicle; comparison means for comparing the actual position of the vehicle to the route to be followed; and means responsive to said comparison means for giving direction commands to the vehicle operator; and particularly manually operable means for inputting data representing a desired route. The means disclosed for detecting an actual position of the vehicle consists of “angle sensors and sensors on the vehicle wheels.” By obeying the direction commands, the operator is able to steer the vehicle along the selected route. The advantage cited for this system is that it does not require a route search algorithm or an extended database and is therefore less complex and less expensive to produce than previously known systems.

U.S. Pat. No. 5,504,482 discloses an optional electro-optical obstacle detection system which is part of a larger automobile navigation guidance, control and safety system.

In terms of the mounting of a device so that it is visible to a vehicle operator but does not interfere with the operator's field of view, U.S. Pat. Nos. 5,667,176, 5,631,638, 4,625,210 and 4,896,855 disclose various mounting arrangements.

None of these vehicle navigation systems are proactive. Most of them require a driver to repetitively study a displayed map, thereby diverting attention away from the road and the safe operation of the automobile.

In general, these prior art systems can be classified into three major types. The first type consists of built-in systems in which the systems are designed into a new vehicle at the factory. The second type consists of after-market adds-on devices in which the devices are securely added to the vehicles after the vehicles are on the ground. The third type consists of those that run on portable computers with a GPS devices attached to the such computers. Even though there are advantages in all these systems, there are significant disadvantages in all them.

The main problem with the built-in systems are their high cost-to-usage ratio. Because they are hardwired into the vehicle and thus cannot be moved from one vehicle to the next, such systems often sit idle most of the time. Furthermore, they are usually dedicated to the single purpose of providing navigational assistance, a need that most people experience only occasionally. And, they are usually only available on the more expensive vehicles.

The main problem with most of the adds-on type navigational systems is that they tend to alter the inside look of the vehicles and also require installations that are often destructive to the vehicles, such as drilling a number of holes on the floor pan of the vehicles in order to allow the system's equipment be held securely while the vehicle is in motion. Once installed, the equipment takes up valuable space and often gets in the way of operator when the system is not in use.

The main problem with the navigation systems utilizing GPS devices with portable computers that the use of such systems can often create a hazardous situation for their users. Such situations arise because it is often difficult to find an easily observable place in the vehicle where portable computer can be securely fastened. So, unless there is a companion traveling with the vehicle operator who can hold and operate the portable computer, the use of such navigation systems may be ill-advised, possibly even an irresponsible act once the vehicle is in motion.

The common problem found in existing navigation systems is that they require the vehicle operator to look at a map, or other means that contains directional information, on some sort of display that is outside the vehicle operator's normal field of view when the vehicle is in motion. In most cases, operators have to turn their heads to look sideways or downward to see the displays. This can make driving with such navigation system a challenging and hazardous task.

Some navigation systems have attempted to overcome this problem by providing synthesized speech feedback to the vehicle operator. However, such solutions are not always viable. For example, in the case of convertible vehicles or when the vehicle's windows are down with loud noises in the vicinity, any voice feedback is often inaudible. In other cases, such as during casual trips, vehicle operators may find such communications to be interruptive of their preferred silence, conduct of a conversation with a passenger, or listening to a radio or stereo.

Every few minutes around the country and the world, there is an accident involving a land, sea or air based transportation system. In some cases, there are no survivors or eye-witnesses to give an account of what happened. Even with eye-witnesses or survivors, there are often disputes of the different accounts of what actually happened. As a result, millions of dollars are wasted in lengthy investigations and litigation leading to higher insurance premiums for society. Moreover, unable to accurately determine the cause of an accident, lessons are not learned to prevent future reoccurrence of similar tragedies.

For many years, ‘black box’ apparatus using audio and electromechanical recording means have been deployed on aircraft to provide investigators important clues of what may have occurred before a plane crash. Likewise, ‘black box’ apparatus using electromechanical means can be found near the engines of some land vehicles which record the speed and operator performance data that allows investigators to recreate a profile of what has occurred based on such physical data. However, one of the most valuable forms of evidence, a visual recording of the actual scene within the vicinity of the subject, are often unavailable.

In theory, one can use a security camera or a camcorder to capture the visual scene of an entire trip. In practice, these kinds of recording systems are only suitable for law enforcement purposes as in a police car or inside a building. This is because in the case of law enforcement and security applications, every minute of what has occurred can be crucial in an investigation. In such applications, there is no way to automatically determine what is important and to just record the portion of the scenario and to skip the rest. However, in the case of accident or incident recording, the general pattern is that only the last few minutes of the record prior to, during and after the accident contain useful information. While capturing a few pictures after an accident has occurred is insufficient and too late, to record scenes of an entire trip is not cost effective and is wasteful because it requires a lot of storage media.

Prior art provided by UK Application GB 2296154A discloses a vehicle workstation equipped with a camera and a persistent storage that records all images of a complete trip beginning to end. This is similar to having a camcorder turning on for the entire trip. Besides being wasteful in storage space as mentioned earlier, the biggest problem is the issue of privacy. Operators in general do not feel comfortable to have everything they do being recorded even when there is no accident or incident involves.

Prior art provided by U.S. Pat. Nos. 5,596,382 and 5,568,211 as well as U.S. Pat. No. 5,262,813 disclose of mechanical apparatus able to capture, via a mechanical camera, a road scene upon impact activated by mechanical trigger mechanisms during a car accident. However, these systems relied solely on rigid mechanical capturing means with limited storage capabilities and are not very flexible in the manner they operate and thus cannot be used conveniently to provide the maximum benefit. These prior inventions focused primarily on trigger mechanisms using mechanical means for land vehicles upon impact.

Prior art JP 9-226635 discloses a digital accident recording device for land vehicle. Despite of the fact that the disclosed invention has an automatic recording feature upon collision similar to this invention, the inventor of the prior art failed to envision the importance of a manual triggering functionality beyond the automatic triggering means. Manual trigger enables an operator to preserve evidence at will even when there is no collision involve. The images preserved using manual triggering means may be snapshots or sequence of visual scenes to include scenes so many seconds before and after the trigger depending on the mode or which manual button to push. Capturing sequence of visual scenes containing so many seconds before and after using the method in this invention is not the same as using a camcorder because the result is different. In the case of using a camcorder, there is no way to record so many seconds before and after by just pulling one trigger. To simulate the effect, using a camcorder, a user would have to push a button to start recording, and then remember to push a button to stop recording. In the event of emergency, a user would not have the time or be able to remember to hit the button a second time. This invention allows user to push a button once and only once to achieve the before and after preservation effect.

Prior art U.S. Pat No. 5,477,141 discloses a method to capture some evidence for incident investigation. Nevertheless, this method only records speed information which is less powerful than visual evidence. This method is also not suitable for applications other than land vehicles such as inside a cabinet of an aircraft.

In addition, many documented cases of accidents are caused by operators not being alert or awake while operating the vehicles. Therefore, in addition to having forward-looking capability in an accident recording apparatus, it is beneficially to provide a backward-looking capability to capture the activities of the operator and the side and back view of an accident scene.

For land vehicle applications, accident avoidance devices have been employed to help operators to avoid potentially dangerous situations. For example, a video scanning system, such as a camera coupled with laser scanners is mounted on the vehicle to scan the road in front of the vehicle and generate image information. The later is computer analyzed in combination with a range sensing system to warn the driver of hazardous conditions during driving by operating a display, and/or a synthetic speech generating means verbally indicating hazardous conditions ahead of the vehicle.

Prior art U.S. Pat No. 5,617,085 teaches a method using a camera and laser beams to track whether a vehicle is going off its own lane and alert operator when this happens. However there are many other potentially hazardous situations which cannot be addressed using this prior art means. As an example, for land applications, under low visibility, there is a need to have an alert system using visual detecting means to warn the operator when there is an object, such as a deer, 100 feet, ahead of the vehicle.

Despite this prior art, the need exists for an improved vehicle navigation and image capturing device with more precise position determining means and a proactive, driver-friendly interface that reduces diversions away from the driver's safe, attentive operation of the vehicle. Still a further need exists in providing vehicle navigation and image capturing device capable of learning and alerting operator of hazardous conditions and preserve evidence interested to an operator or investigator.

### SUMMARY OF THE INVENTION

The present invention is generally directed to satisfying the needs set forth above and the problems identified in the prior arts. The problem of high cost-to-usage ratio is solved by making the device portable so that it can be moved from one car to another, thereby making it possible to increase the percentage of time that the device is in use. Additionally, the present invention is designed so as to be capable of performing more than just navigational assistance tasks, thereby further increasing its probable percentage of time in use.

Installation problems with prior navigational systems are overcome by providing the present invention with unique mounting capabilities. Similarly, problems associated with the inadequacy of the communication capabilities of prior systems are overcome by the use of a set of directional indicators which are located underneath the vehicle's rearview mirror so that the indicators lie within the vehicle operator's normal field of view.

More particularly, the present invention is directed to an improved, proactive vehicle guidance device that is capable of detecting and interpreting visual information in the vicinity of a vehicle in order to provide the vehicle operator with appropriate navigational guidance assistance and to compensate for the positioning errors embedded in commercial GPS signals. The invention further relates to the integration and improvement of various technologies and methods to provide a practical vehicular navigation system that is both safe and accurate to use.

Another objective of the invention is to capture the visual scene of an incident so many seconds before, during and after the incident has occurred involving a land vehicle to include a passenger car, bus, van, truck and train.

Another objective of the invention is to capture the visual scene of an incident so many seconds before, during and after the incident has occurred involving a sea-based vehicle to include a speed-boat.

Another objective of the invention is to capture the visual scene of an incident so many seconds before, during and after the incident has occurred involving an air-based transportation system such as a passenger jet.

Another objective of the invention is to capture the activities of the operator of a transportation system so many seconds before, during and after an incident has occurred.

Yet another objective of the invention is to capture the sound wave of an incident so many seconds before, during and after the incident has occurred as a supplement to the visual evidence.

Yet another objective of the invention is to allow the same apparatus to be used as an external monitoring device for recording incidents of moving subjects.

Yet another objective of the invention is to allow the same apparatus to be used as a hand-held device for recording incidents.

Yet another objective is to have a means to “teach” the system to distinguish hazardous and inconsequential conditions and to alert operator only when the situation is potentially hazardous.

Yet another objective of the invention is to reduce manufacturing cost by allowing the same apparatus to be used in multiple environments for applications having similar patterns.

In accordance with one preferred embodiment of the present invention, the foregoing need can be satisfied by providing a vehicle-mounted, navigation device, comprising: a computational unit having: (A1) a computational microprocessor, and (A2) a computational memory and storage device coupled to the computational microprocessor for providing both temporary and persistent storage capabilities, a communications unit having: (B1) a data input and output port connected to the computational unit that receives data from and communicates data to an external computer, (B2) a global position system (GPS) antenna and receiver that are connected to said computational unit for receiving signals from GPS satellites, wherein said computational unit further comprises the means for processing said GPS signals to determine the current position of said vehicle, and (B3) means for providing communications from said computational unit to the vehicle operator, said means connected to said computational unit and chosen from the group consisting of: (B3i) a directional indicator screen that displays icons which provide navigational information in a visual form, and (B3ii) a voice input-output system having an audio receiver, which is connected to said computational unit so that the vehicle operator may speak into the receiver and have said spoken message converted into digital information for input into said computational unit, and a sound generating device that uses portions of the computational unit's digital output to provide the vehicle operator with navigational information in an audible form, a vision unit having: (C1) an image capturing device for detecting visual information that comes within the vicinity of the vehicle, this visual information including road and traffic signs nearby the traveled roadway, markings on the traveled roadway and the general scenery adjacent to the traveled roadway, (C2) a vision microprocessor coupled to the image capturing device and running image enhancement and pattern recognition software for converting the detected visual information into digital information, (C3) a vision memory device coupled to the vision microprocessor, (C4) a persistent memory device coupled to the vision microprocessor, (C5) means connected to the vision microprocessor for automatically storing on a periodic basis in the persistent memory device a plurality of consecutive frames of detected visual information that comes within the vicinity of the vehicle, and (C6) means connected to the vision microprocessor for manually triggering the storage in the persistent memory device of consecutive frames of detected visual information that comes within the vicinity of the vehicle, wherein the stored frames can be used for various purposes, including accident aftermath analysis and documentation of the visual aspects of an event or scene that occurs within the vicinity of the vehicle, and a mounting assembly for mounting these units so as to allow the units to be securely and steadily positioned, while at the same time causing minimum interference with the vehicle operator's field of view, this assembly providing for a mounting arrangement chosen from the group consisting of mounting the units behind the vehicle's rearview mirror, mounting the units as an integral part of the vehicle's rearview mirror and mounting the units so that they attach to the vehicle's front windshield.

In a preferred embodiment, for a vehicle having a rearview mirror with a mirror attached to the front surface of a frame and from the rear side of the frame extends a mounting arm that holds the frame in a desired position and connects the frame to an interior surface of the vehicle, the mounting assembly for mounting these units behind the vehicle's rearview mirror comprises: (a) a case having a box-shape with inner and outer surfaces, including outer front and top surfaces, the units being operationally connected to the inner surfaces so that the case forms a protective enclosure for the units, the case so configured and of a size so that, when the front surface of the case is in close proximity to the rear surface of the rearview mirror frame, the vehicle operator's field of view is not obstructed, and the outer top surface of this case having a recessed portion that accommodates the rearview mirror frame's mounting arm while allowing the front outer surface of the case to be placed in close proximity to the rear surface of the rearview mirror frame, (b) a ball joint attached to the case's outer top surface, (c) an extendible pole having a top end and a bottom end, said bottom end being attached to the ball joint, said pole having a plurality of tubular members that are retractably enmeshed with each other, (d) a clamp having a clamp base, a pair of clamping jaws attached to the clamp base, and means coupled to the clamping jaws for biasing the clamping jaws towards one another so that they releasably affix said clamp to said rearview mirror frame mounting arm, and (d) a hinge that couples the clamp base with the top end of the extendible pole.

In a second preferred embodiment, for mounting these units so that they attach to the vehicle's front windshield, the mounting assembly comprises: (a) a case having a boxshape with inner and outer surfaces, including outer front and top surfaces, the units being operationally connected to the inner surfaces so that the case forms a protective enclosure for the units, the case so configured and of a size so that the case provides minimum obstruction to the vehicle operator's field of view, (b) a ball joint attached to the case's outer top surface, (c) an extendible pole having a top end and a bottom end, the bottom end being attached to the ball joint, the pole having a plurality of tubular members that are retractably enmeshed with each other, (d) a mounting platform having a base, a mounting arm extending from the base, and a plurality of adhesive pads cups attached to the base that releasably affix the platform to the front windshield of the vehicle, (e) a clamp having a clamp base, a pair of clamping jaws attached to the clamp base, and means coupled to the clamping jaws for biasing the clamping jaws towards one another so that they releasably affix the clamp to the mounting arm of the mounting platform, and (f) a hinge that couples the clamp base with the top end of the extendible pole.

In a third preferred embodiment, for mounting the units as an integral part of the vehicle's rearview mirror, the mounting assembly comprises: a case having a box-shape with inner and outer surfaces, including outer front, back and side surfaces, the units being operationally connected to the inner surfaces so that the case forms a protective enclosure for the units, wherein the vehicle has a rearview mirror assembly that is especially configured to mesh with the case, the rearview mirror assembly comprising a frame having a pair of leg portions horizontally spaced apart from one another and connected by a middle portion, which has a front, rear and top surface, the middle portion extending between and connected to the leg portions so as to define a slot in the frame for receiving and supporting the sides of the case therein between the leg portions and the rear surface of the middle portion, wherein the rearview mirror assembly further comprising a mirror attached to the front surface of the middle portion of the frame, a mounting arm having a top and bottom end, the bottom end being attached to the top surface of the middle portion, the arm holding the frame in a desired position with top end of the arm connected to an interior surface of the vehicle.

This new and improved, vehicle mounted, navigation device is seen to achieve its object of enhancing a vehicle operator's ability to comprehend and quickly react to all the information that comes within the field of view of the vehicle, thereby enhancing the operator's navigational capabilities.

Other objects and advantages of this invention will become readily apparent as the invention is better understood by reference to the accompanying drawings and the detailed description that follows.

### BRIEF DESCRIPTION OF THE DRAWINGS

FIG. 1 is a schematic block diagram showing the essential components of one embodiment of the present invention.

FIG. 2 is a schematic block diagram showing in more detail the essential components of one embodiment of the present invention.

FIG. 3 is a top view of a preferred embodiment of the vehicle mounted, navigation device.

FIG. 4 is a side view of a preferred embodiment of the vehicle mounted, navigation device.

FIG. 5 is a top-rear perspective view of the navigation device wherein its mounting assembly provides for the device to be mounted behind the vehicle's rearview mirror.

FIG. 6 is a front perspective view of the navigation device shown in FIG. 5.

FIG. 7 is a side view of the navigation device wherein its mounting assembly provides for the device to be mounted behind the vehicle's rearview mirror.

FIG. 8 is a rear view, as if looking through the vehicle's front windshield and into the vehicle, of the navigation device shown in FIG. 7.

FIG. 9 is a top-rear perspective view of the navigation device wherein its mounting assembly provides for the device to be mounted as an integral part of the vehicle's rearview mirror.

FIG. 10 is a front perspective view of the navigation device shown in FIG. 9.

FIG. 11 is a side view of the navigation device wherein its mounting assembly provides for the device to be mounted as an integral part of the vehicle's rearview mirror.

FIG. 12 is a rear view of the navigation device shown in FIG. 11.

FIG. 13 is a side view of the navigation device wherein its mounting assembly provides for the device to be attached to the vehicle's front windshield.

FIG. 14 is a rear view of the navigation device shown in FIG. 13.

FIG. 15 is a schematic block diagram showing the essential components of the computational, communications and vision units for one embodiment of the present invention.

FIG. 16 is a schematic block diagram showing a strip down version of the system that provides a more narrowed focus of the present invention without the communications units.

FIG. 17 is a schematic block diagram showing in more detail the essential components of one embodiment of the present invention without the communications unit.

FIG. 18 is a schematic block diagram showing one preferred embodiment of how to preserve a fixed number of images using a finite storage for an unlimited period of time.

FIG. 19 is a schematic block diagram showing another preferred embodiment of how to preserve a fixed number of images using a finite storage for an unlimited period of time.

FIG. 20 is a flow chart illustrating a learning mode of vision and recognition system configured in accordance with the invention;

FIG. 21 is a flow chart illustrating an operational mode of the vision and recognition system.

### DESCRIPTION OF THE PREFERRED EMBODIMENT

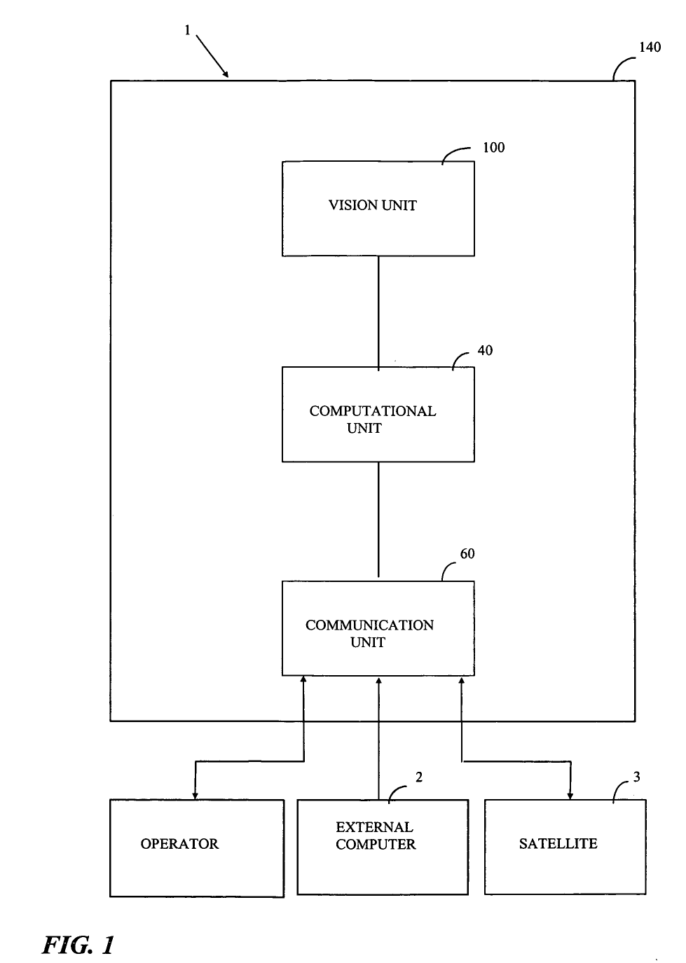

Referring now to the drawings wherein are shown preferred embodiments and wherein like reference numerals designate like elements throughout, there is shown in FIG. 1 a schematic block diagram showing the essential components of one embodiment in accordance with the present invention.

As shown in FIG. 1, the vehicle mounted, navigation device, 1, comprises: a computational unit, 40, a communications unit, 60, a vision unit, 100 and a mounting assembly, 140, for mounting the units so as to allow them to be securely and steadily positioned, while at the same time causing minimum interference with the vehicle operator's field of view.

The device's mounting assembly, 140, is designed to enable the device, 1, to be fitted into almost any vehicles and, for the most part, hidden behind the vehicle's existing rearview mirror so as to avoid blocking driver's field of view and also to minimize altering the look and feel of the original interior of the vehicle.

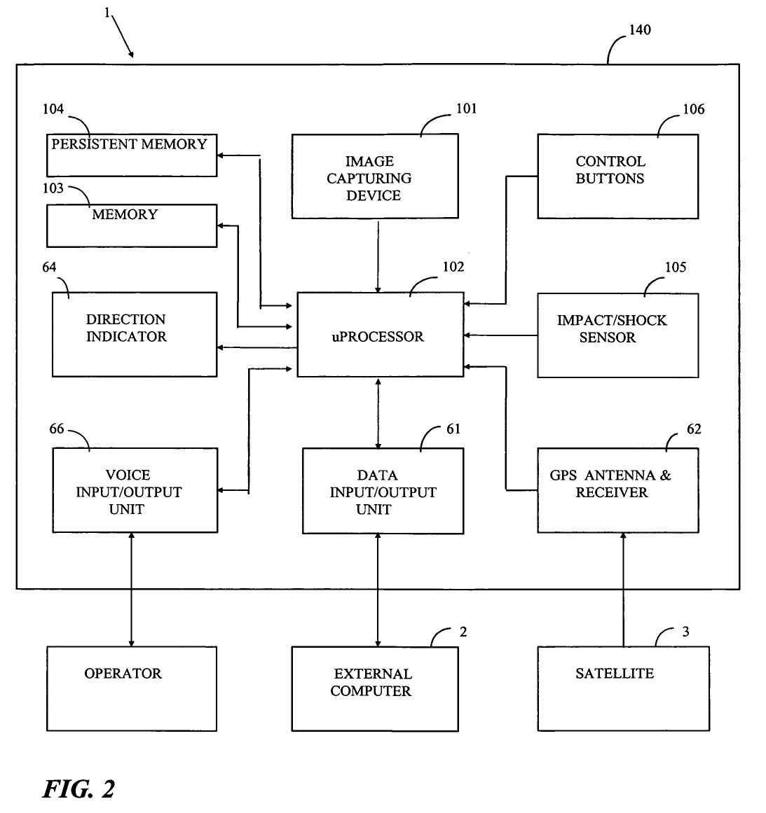

FIG. 2 is a schematic block diagram showing in more detail the essential components of one embodiment of the present invention. It is seen to comprise: an image capturing device, 101, for detecting visual information that comes within the vicinity of the vehicle, the visual information including road and traffic signs nearby the traveled roadway, markings on the traveled roadway and the general scenery adjacent to the traveled roadway, a microprocessor, 102, coupled to the image capturing device, 101, and running image enhancement and pattern recognition software for converting the detected visual information into digital information, a memory device, 103, coupled to the microprocessor, 102, a persistent memory device, 104, means, 105, such as a impact/shock sensor, connected to the vision microprocessor, 102, for triggering the automatic storage in the persistent memory device, 104, of a plurality of consecutive frames of detected visual information that comes within the vicinity of the vehicle, and means, 106, such as a control button, connected to the vision microprocessor, 102, for manually triggering the storage in the persistent memory device, 104, of consecutive frames of detected visual information that comes within the vicinity of the vehicle, wherein the stored frames can be used for various purposes, including accident aftermath analysis and documentation of the visual aspects of an event or scene that occurs within the vicinity of the vehicle.

Additional elements shown in FIG. 2 include: a data input and output port, 61, connected to the microprocessor, 102, that receives data from and communicates data to an external computer, 2, a global position system (GPS) antenna and receiver, 62, that are connected to the microprocessor, 102, for receiving signals from a GPS satellite, 3, wherein the microprocessor, 102, further comprises the means for processing said GPS signals to help determine the current position of said vehicle, and the means, 63, for providing communications from the microprocessor, 102, to the vehicle operator, this means, 63, being connected to the microprocessor, 102, and chosen from the group consisting of a directional indicator screen, 64, that displays icons, 65, which provide navigational information in a visal form, and a voice input-output system, 66, having an audio receiver which is connected to the microprocessor, 102, so that the vehicle operator may speak into the receiver and have this spoken message converted into digital information for input into the microprocessor, 102, and a sound generating device that uses portions of the computational unit's digital output to provide the vehicle operator with navigational information in an audible form.

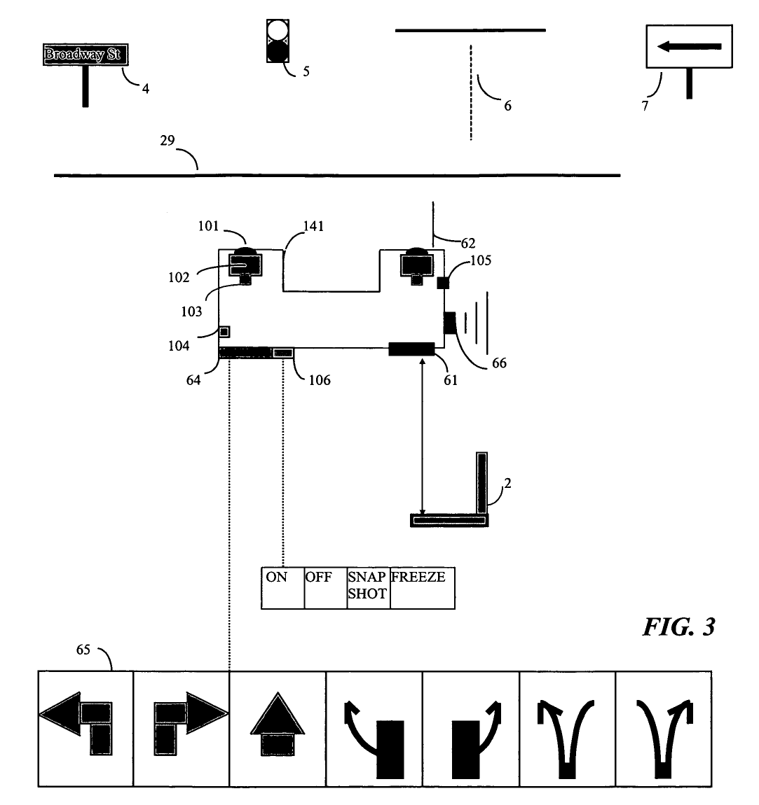

FIG. 3 is a top view of a preferred embodiment of the present invention. Shown are: an image capturing device, 101, for detecting visual information that comes within the vicinity of the vehicle, the visual information including road, 4, and traffic, 5, signs nearby the traveled roadway, markings, 6, on the traveled roadway and the general scenery, 7, adjacent to the traveled roadway. Coupled to the image capturing device, 101, are a microprocessor, 102, a memory device, 103, a persistent memory device, 104, means, 105, such as a impact/shock sensor, for triggering the automatic storage in the memory device, 104, of a plurality of consecutive frames of detected visual information that comes within the vicinity of the vehicle, and means, 106, such as a control button, for manually triggering the storage in the persistent memory device, 104, of consecutive frames of detected visual information that comes within the vicinity of the vehicle, a data input and output port, 61, that receives data from and communicates data to an external computer, 2, a global position system (GPS) antenna and receiver, 62, a directional indicator screen, 64, that displays icons, 65, which provide navigational information in a visual form, and a voice input-output system, 66.

For navigational purposes, the external computer, 2, is used by the vehicle operator to help determine the desired travel route. This is accomplished by having the external computer, 2, run map software that is capable of displaying a map representing the roadways in the desired area of travel. The vehicle operator inputs the vehicle's desired destination. The device, 1, interacts with the computer, 2, to guide the operator to travel on selected roadways and allows the operator to see the current vehicle position along its travel path on the computer's display screen. Alternatively, the travel route data can be downloaded from the external computer, 2, via the input and output port, 61, and stored in the device's memory, 103; thereby, allowing the external computer, 2, to be put away during the trip for driving safety reason. And in the case when a computer, 2, is not available, the operator can specify a traveling route as a sequence of street names, traffic lights and turns information via a voice input-output system, 66. In this situation, the device, 1, will use its imaging capability alone to provide direction guidance so as to relieve the driver of having to memorize the travel instructions or constantly look up written directions.

To notify the vehicle operator of when to make turns, in addition to an audio prompt, the device, 1, provides a directional indicator screen, 64, that is located at the bottom of the mounting assembly's case, 141. This screen may be pulled down via a lever, thereby allowing the screen to hang right underneath and behind the vehicle's rearview mirror, 10, and thus within the vehicle operator's field of view. This directional indicator screen, 64, may be illuminated by light emitting diodes (LEDs) controlled by the microprocessor.

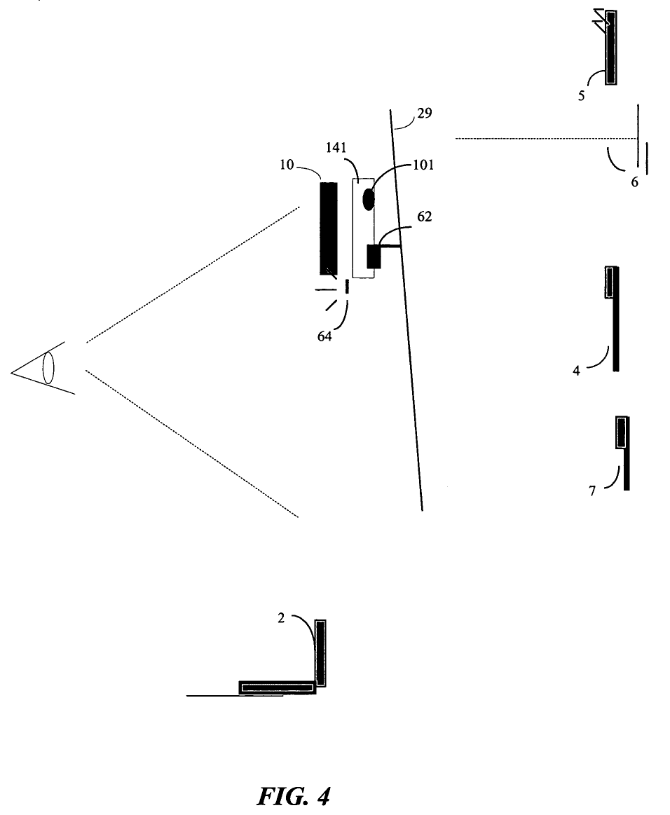

FIG. 4 is a side view of a preferred embodiment of the present invention. It shows the approximate spatial relationship between an image capturing device, 101, of the present invention and the visual information that comes within the vicinity of the vehicle. This visual information including road, 4, and traffic, 5, signs nearby the traveled roadway, markings, 6, on the traveled roadway and the general scenery, 7, adjacent to the traveled roadway. In this embodiment the invention's mounting assembly, 140, includes a case, 141, that is mounted behind the vehicle's rearview mirror. It can be noted that the mounting of the device, 1, do not interfere with the operator's field of view.

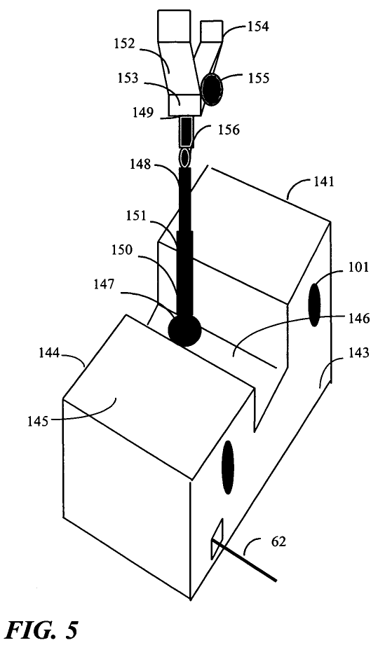

FIG. 5 is a top-rear perspective view of the navigation device wherein its mounting assembly provides for the device to be mounted behind the vehicle's rearview mirror. In this embodiment the invention's mounting assembly, 140, is seen to comprise: a case, 141, having a box-shape with inner and outer surfaces, including outer front, 144, rear, 143, and top, 145, surfaces, wherein the case, 141, is so configured and of a size so that, when the front surface, 144, of the case, 141, is in close proximity to the rear surface, 14, of the vehicle's rearview mirror frame, 12, the vehicle operator's field of view is not obstructed. This is due in part to the outer top surface, 145, of the case, 141, having a recessed portion, 146, that accommodates the rearview mirror frame's mounting arm, 15, while allowing the outer front surface, 144, of the case, 141, to be placed in close proximity to the rear surface, 14, of the vehicle's rearview mirror frame, 12.

FIG. 5 further shows that this embodiment of the mounting assembly, 140, comprises: a ball joint, 147, attached to the case's outer top surface, 145, an extendible pole, 148, having a top end, 149, and a bottom end, 150, wherein the bottom end, 150, is attached to the ball joint, 147, with the pole, 148, having a plurality of tubular members, 151, that are retractably emeshed with each other, a clamp, 152, having a clamp base, 153, a pair of clamping jaws, 154, attached to the clamp base, 153, and means, 155, such as a screw knob, coupled to the clamping jaws, 154, for biasing the clamping jaws towards one another so that they releasably affix the clamp, 152, to the rearview mirror frame's mounting arm, 15, and a hinge, 156, that couples the clamp base, 153, with the top end, 149, of the extendible pole, 148.

The device, 1, is to be attached to the mounting arm, 15, of the rearview mirror, 10, with a clamp, 152, that in the embodiment shown in FIG. 5 is tightened with a screw knob, 155. To clear the mounting arm, 15, holding the existing mirror frame, 12, and to allow the device, 1, to be installed and adjusted within the constrained, tight, interior space environment of a vehicle, a number of specific mechanical arrangements are made in the mounting assembly, 140; these include the case's recessed portion, 146, an extendible pole, 148, for raising or lowering the case, 141, a hinge, 156, on the extendible pole, 148, and a ball joint, 147, at the bottom of the pole, 148, for adjusting the position of the case, 141, relative to the vehicle's rearview mirror, 10.

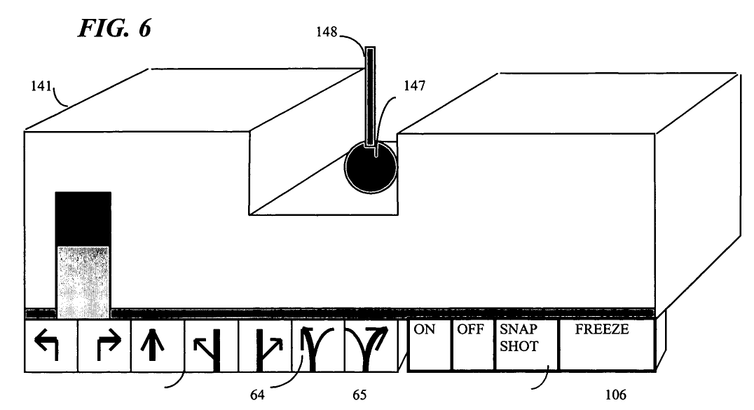

FIG. 6 is a front perspective view of the navigation device shown in FIG. 5. The directional indicator screen, 64, that displays icons, 65, is seen to be mounted near the bottom of the mounting assembly case, 141, so that the screen, 64, will extend slightly below the bottom of the vehicle's rearview mirror and in such a manner so as not to impede the vehicle operator's field of view.

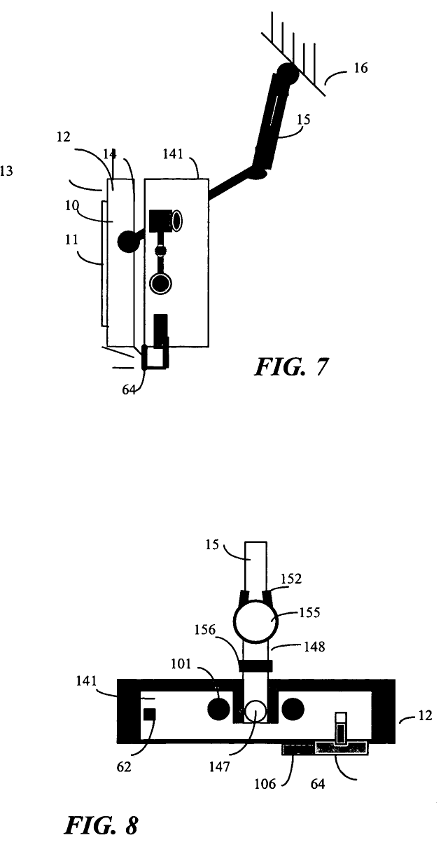

FIG. 7 is a side view of an embodiment of the present invention wherein its mounting assembly provides for the device to be mounted behind the vehicle's rearview mirror. In this configuration, the vehicle is seen to have a rearview mirror, 10, with a mirror, 1, attached to the front surface, 13, of a frame, 12, and from the rear side, 14, of this frame, 12, extends a mounting arm, 15, that holds the frame in a desired position and connects the frame to an interior surface, 16, of the vehicle. Further details of how this embodiment of the present invention fits with the vehicle's rearview mirror, 10, can be seen in FIG. 8 which is a rear view, as if looking through the vehicle's front windshield and into the vehicle, of the navigation device shown in FIG. 7.

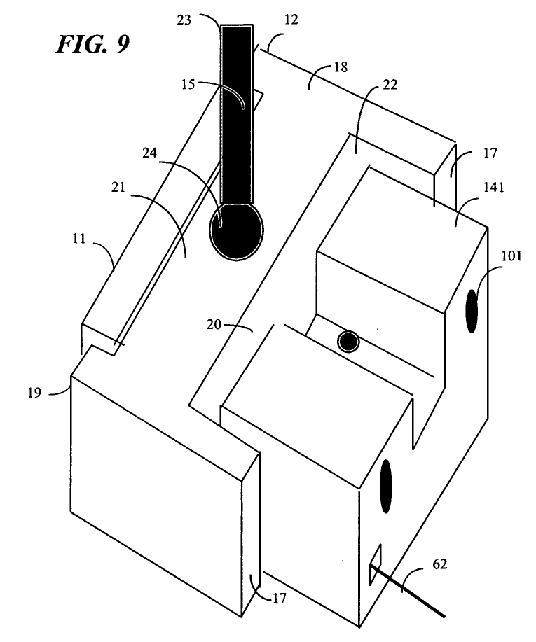

FIG. 9 is a top-rear perspective view of the navigation device wherein its mounting assembly provides for the device to be mounted as an integral part of the vehicle's rearview mirror. In this configuration, the vehicle is seen to have a rearview assembly that is especially configured to mesh with the mounting assembly case, 141, with the rearview mirror assembly comprising a frame, 12, having a pair of leg portions, 17, horizontally spaced apart from one another and connected by a middle portion, 18, which has a front, 19, rear, 20, and top, 21, surface. The middle portion, 18, extends between and connects to the leg portions, 17, so as to define a slot, 22, in the frame, 12, for receiving and supporting the sides of the case, 141, therein between the leg portions, 17, and the rear surface, 20, of the middle portion, 18. This rearview mirror assembly further comprises a mirror, 11, attached to the front surface, 19, of the middle portion, 18, of the frame, with a mounting arm, 15, having a top, 23, and bottom, 24, end, the bottom end, 24, being attached to the top surface, 21, of the middle portion, 18, with the arm, 15, holding the frame, 12, in a desired position with top end, 23, of the arm connected to an interior surface, 16, of the vehicle.

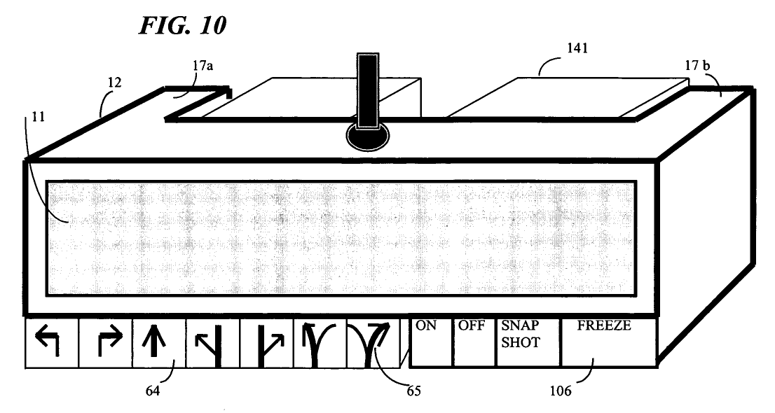

FIG. 10 is a front perspective view of the navigation device shown in FIG. 9. The directional indicator screen, 64, that displays icons, 65, is seen to be mounted near the bottom of the mounting assembly case, 141, so that the screen, 64, will extend slightly below the bottom of the vehicle's rearview mirror and in such a manner so as not to impede the vehicle operator's field of view.

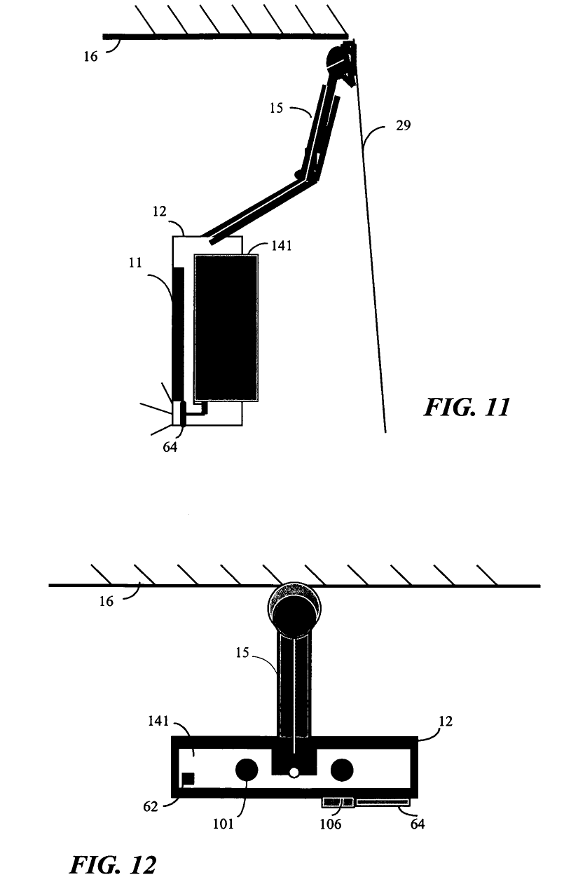

FIG. 11 is a side view of the navigation device shown in FIG. 9. The manner of attachment of the rearview mirror assembly to an interior surface, 16, of the vehicle is shown FIG. 12 provides a rear view of this assembly.

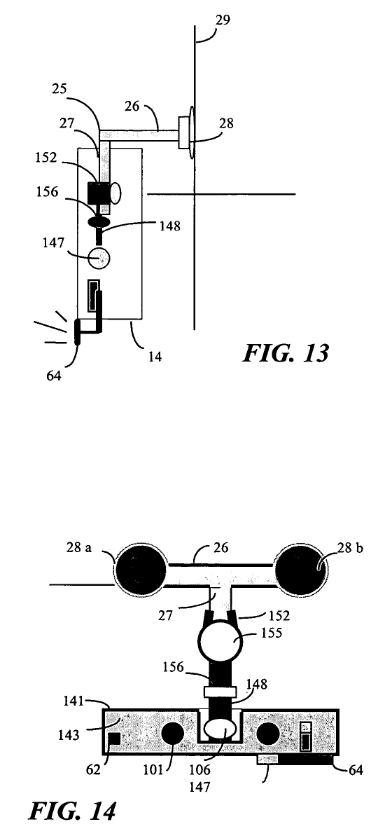

FIG. 13 is a side view of the navigation device wherein its mounting assembly provides for the device to be attached to the vehicle's front windshield. To allow for this, the mounting assembly in this embodiment further includes: a mounting platform, 25, having a base, 26, a mounting arm, 27, extending from the base, 26, and a plurality of adhesive pads, 28, attached to the base and which releasably affix the platform, 25, to the front windshield, 29, of the vehicle. Also shown in FIG. 13 are other key elements of the mounting assembly of the present invention, including: a case, 141, a ball joint, 147, attached to the case's outer top surface, 145, an extendible pole, 148, a clamp, 152, and a hinge, 156.

FIG. 14 is a rear view of the navigation device shown in FIG. 13. The case's outer, rear surface, 143, is seen to have attached to it a GPS antenna and receiver, 62, an image capturing device, 101, and a directional indicator screen, 64.

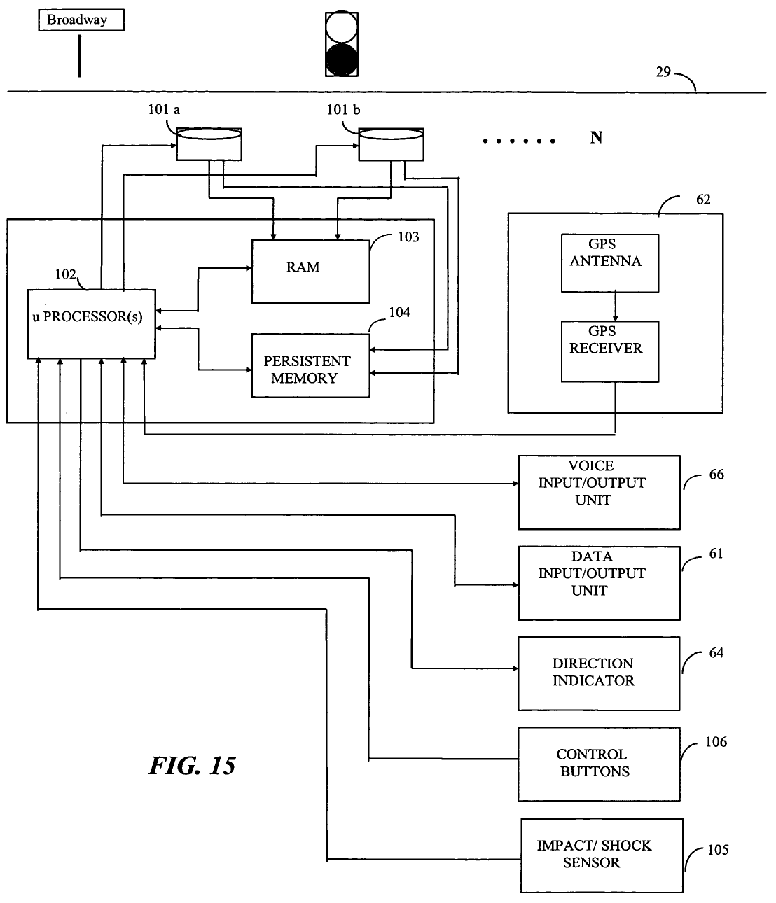

FIG. 15 is a schematic block diagram showing the essential components of the computational, communications and vision units for one embodiment of the present invention. Key elements shown include: an image capturing device, 101, for detecting visual information that comes within the vicinity of the vehicle, a microprocessor, 102, coupled to the image capturing device, 101, a memory device, 103, and a persistent memory device, 104, coupled to the microprocessor, 102. Also coupled to the microprocessor, 102, are: means, 105, such as a impact/shock sensor, for triggering the automatic storage in the persistent memory device, 104, of a plurality of consecutive frames of detected visual information that comes within the vicinity of the vehicle, and means, 106, such as a control button, for manually triggering the storage in the persistent memory device, 104, of consecutive frames of detected visual information, a data input and output port, 61, that receives data from and communicates data to an external computer, 2, a global position system (GPS) antenna and receiver, 62, a directional indicator screen, 64, that displays icons, 65, which provide navigational information in a visual form and a voice input-output system, 66, that converts a vehicle operator's spoken message into digital information for input into the microprocessor, 102, while also using portions of the computational unit's digital output to provide the vehicle operator with navigational information in an audible form.

The device's ability to capture and store consecutive frames of visual information that comes within the vicinity of the vehicle means that the device, 1, can be used for purposes other than strictly navigation. For example, an image capturing device may be triggered to essentially taking snapshots of scene while the vehicle is in motion and keep the last few seconds of such images in the device's persistent memory, 104. In case of a car crash, these stored image can be retrieved for aftermath analysis the device, 1, is also equipped with a manual trigger to allow the vehicle's operator to take snapshots of scene deemed to be worth capturing and saving.

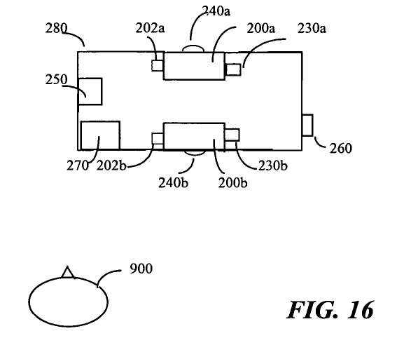

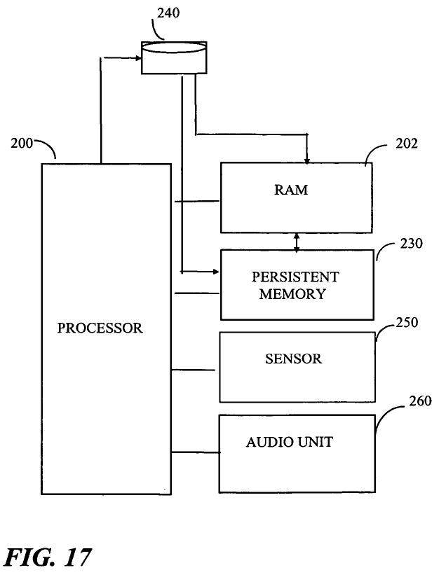

As shown in FIGS. 16 and 17, the digital system comprises: a control unit, 200, for operating the system; a memory unit, 202, for temporary storage; a forward-looking image capturing unit, 240a, for capturing front view scenes; a backward looking image capturing unit, 240b, for capturing the rear and side view as well as the activities of the operator, 900; a digital sound recorder, 260, for capturing the surrounding sound wave to sync up with the recorded images captured by the imaging unit, 240a and b; a persistent storage, 230, for providing persistent storage of the images captured by the image capturing unit, 240a, b, and sound wave captured by the sound recorder, 260; a power source, 270, to supply the power to allow for continuing operation and a protective housing, 280, to protect the overall construction of the system.

An image capturing unit, 240 may include a CCD or CMOS device. In addition to the temporary memory 202, the inventive device further includes a persistent storage 230. The device further includes at least one a digital sensor, 250 for sensing external events and operating to trigger the termination of capturing process of images and audio so as to preserve the data in the persistent storage 230 and the sound recorder, 260. The control unit, 200 operates to couple all major units to one another and to provide overall synchronization and operational control.

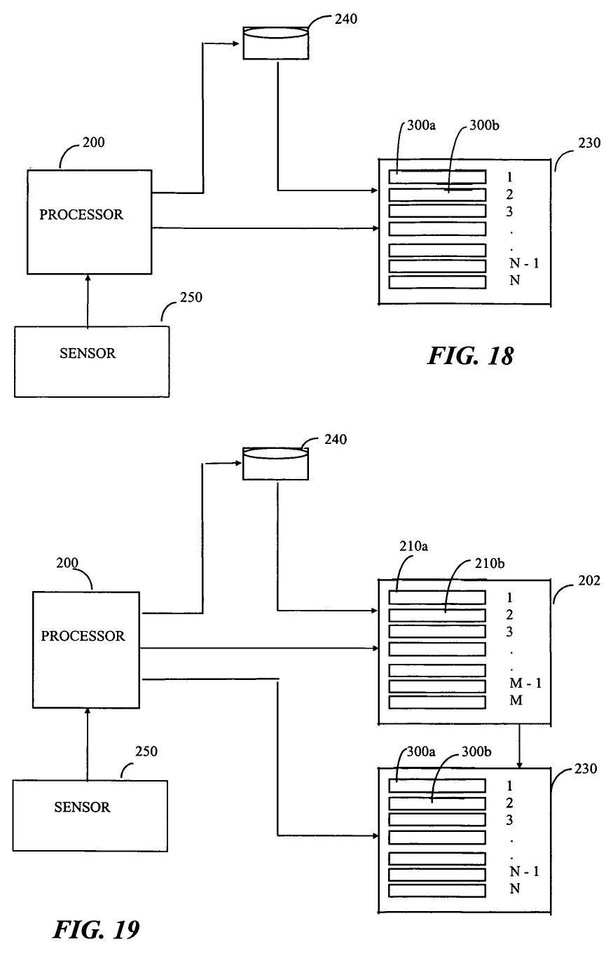

FIG. 18 is a detailed block diagram showing one preferred embodiment wherein images captured by image capturing unit, 240, are fed into a persistent storage, 230, which has a limited storage capacity made up of N numbers of individual storage cells, 300a, 300b and so on. The captured images are to be stored into each cell in a first-in-first-out fashion such that at any given time, a fixed number of images are to be buffered up representing the consecutive frames of actual scene. With such an arrangement, the latest images captured will replace the earliest images when the last storage cell is reached until such time when the control unit, 200, stops any further images to be inserted into a cell so that the buffered images can be persistently preserved. The number of consecutive images to be preserved is a function of the number of storage cell N. This mechanism is designed to overcome the storage problem associated with the fact that an incident can occur at any time within an unlimited time span, therefore it is essential to have an economical way to selectively preserve only valuable data.

FIG. 19 is another preferred embodiment wherein the captured images are to be first inserted into the volatile memory, 202, and from which the data are then pull into the persistent storage, 230, controlled by the control unit, 200. The volatile memory, 202, has cells 210a, 210b and up to M counts. Data is inserted first-in-first-out fashion.

It is to be noted that in addition to holding captured images, the persistent storage, 230, along with the storage mechanism as shown in FIGS. 18, 19 can be used to hold digital sound wave captured by the audio unit, 260. Furthermore, the persistent storage, 230, can be used to hold computer executable instructions and thus replaces or eliminates the memory unit, if so chosen. It is worth to point out that persistent storage, 230, may be substituted by other forms of persistent storage media to achieve a similar result even though most of such persistent storage media tend to have a slower performance. Moreover, the persistent storage, 230, can also be achieved or simulated by continuously powering up the volatile memory so as to retain its contains. Likewise, the control unit, 200, can be selected from the group consisting of a microprocessor, a micro-controller, a DSP, a PAL, an EPLD, a FPGA and other forms of programmable logic circuits to provide the necessary control functionality. The inclusion of volatile memory is not necessary, and the device may be totally functional with only the persistent memory 230.

The digital system illustrated in previous figures is typically displaceably attached to a convenient support surface, such as a windshield offering a fairly broad and relatively unobstructed field of view. However, in situations requiring manual operation of the system, such as when the field of view is not sufficient due to natural or artificial obstructions preventing the mounted system from capturing events, the system can be operatively dismounted for further hand-held operations. While various installation means can be configured to provide operative removal of the digital system from the support surface, in general, it has an installation base fixed to the support surface and dimensioned to removably receive the housing 280 of the digital system. Thus, when the circumstances dictate the use of the digital system as a recording apparatus by manually taking still pictures (snap shots) of or continuously recording the scenes of interest, the operator 900 simply removes the system from the base.

In use, the digital system operates in several modes defined by the control unit 200. In an automatic mode of the control unit, the digital system is mounted in the base and captures an incident in response to a signal output by the sensor 250. In this mode, the control unit 200 allows recording for a period before, during and after the event that has triggered the output of the sensor 250.

Alternatively, the operator 900 can manually activate a triggering event by manually actuating a button causing a triggering signal. Numerous events may attract the operator's attention causing him/her to permanently record an event. This can be in various forms choosing from the group containing taking snapshots, taking sequence of images, freezing the last image captured and taking sequence of images that contains so many seconds before and after said trigger.

Moreover, if a situation calls for portable use of the digital system, the operator 900 can remove it from the installation base and, while holding the system in his/her hands, operate it as a digital camera taking still pictures by simply activating the button in a predetermined manner. Inherently, actuation of the button can happen any time irregardless of the specific mode in which the digital system currently operates.

The microprocessor, 102, executing software selecting from the group consisting of pattern recognition and edge detection methods, equipped with a knowledge-base database system, is capable of discriminating between hazardous and inconsequential conditions captured by the cameras. In accordance with the main concept of the present invention, if the images captured by the system resembling a hazardous condition, it generates a control signal alerting the operator, who can react accordingly. To be able to differentiate between the hazardous and innocuous events, the system is provided with a learning mode, in which it is trained to recognize both images associated with hazardous and harmless events. Alternatively to the learning mode, an operator when receiving an alert in real-time can overrule the alert and instruct the system to ignore the condition if it encounters similar pattern in the future.

The system is designed to enhance the performance of the operator by having the camera detect road obstacles and warn the driver about captured obstacles, particularly under low visibility conditions, such as night time, foggy whether and rainy days, by using the camera equipped with special vision equipment such as infra-red light. Using a land vehicle application as an example, the system can be trained to warn the operator when she drives towards a large-size hole on a road or driving towards a closed crossbar at the railroad intersection or at a red light.

On the other hand, events considered by the driver as harmless may also be inputted and stored in the system. The system is trained to recognize and ignore these events. An example of harmless events may be activation of the windshield wipers. A further example may include recognizing objects, such as rocks on a road, not exceeding a predetermined size.

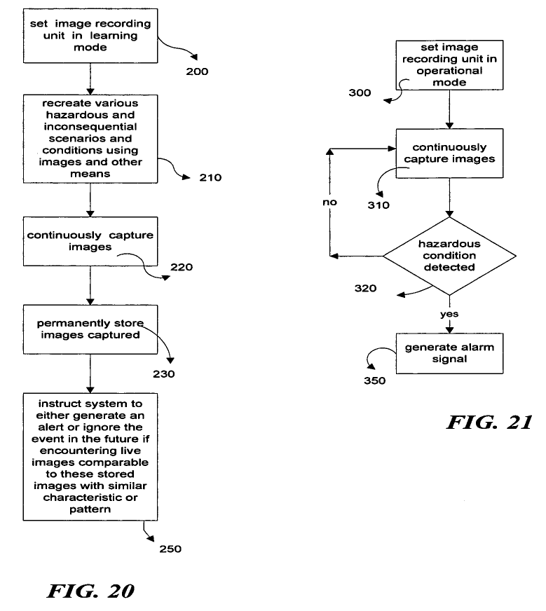

Turning now to FIG. 20, the inventive device is shown operating in a learning mode providing the device with a capability of recognizing images as either hazardous or harmless events. The inventive device is provided with an arrangement of buttons or other switches allowing the operator to set the device in a learning mode. To begin the training process, the whole system including processor 200 (FIG. 16) is turned on, as indicated by a step 200. Various scenarios, mostly involving images, are created or recreated as in step 210. As the camera works, it captures images of events being recreated as in step 220 and then stored as in step 230. The operator or a subject matter expert, using his own judgment, may define any given event as either hazardous or harmless, as illustrated by a step 250. As the result, the operator “teaches” the device to distinguish harmful and harmless events or conditions. Alternative to having the operator to train the system, a pre-loaded knowledge base can be provided at the factory level.

The operational mode of the inventive system is illustrated in FIG. 21. The system is turned on, as illustrated by a step 300. Note that the operational mode is not necessarily associated only with a moving vehicle; the latter may very well be idle. While continuously capturing images of events, as shown by a step 310, the system is operative to identify a hazardous condition using stored images as mentioned before with software executing known or commercial algorithms selecting from the group consisting of edge detection and pattern recognition methods, as indicated by a step 320. If the captured images are considered pseudo-hazardous or harmless, the system continues to work without generating a warning signal. Otherwise, an alert is generated to warn the operator of potential danger based on the capture images as shown in step 350. The operator may, however, manually operate the system instructing it to ignore any hazardous condition in the operational mode. Thus, the inventive system is taught to selectively warn the driver about this hazardous condition. As in learning mode, the operator can manually capture any scene at any time and instruct the system to generate an alert when encounters scenes with the same patterns in the future.

It thus will be appreciated that a new and improved visual-information-stimulated, navigation device, 1, has been described which achieves the objects of enhancing an individual's ability to comprehend and quickly react to all the information that visually comes within the field of view of the individual thereby enhancing the individual's performance.

This document describes the inventive sound transfer methods and devices implementing these methods for illustration purposes only. Neither the specific embodiments of the invention as a whole, nor those of its features limit the general principles underlying the invention. In particular, the invention is not limited to digital storage, recording, and transmission devices, but includes analog devices. The specific features described herein may be used in some embodiments, but not in others, without departure from the spirit and scope of the invention as set forth. Many additional modifications are intended in the foregoing disclosure, and it will be appreciated by those of ordinary skill in the art that in some instances some features of the invention will be employed in the absence of a corresponding use of other features. The illustrative examples therefore do not define the metes and bounds of the invention and the legal protection afforded the invention, which function is served by the claims and their equivalents.

1. A digital in-vehicle device comprising:
an image capturing device for continuously capturing actual scene in real-time;
a vision microprocessor coupled to said image capturing device for controlling the operation of said image capturing device,
a vision memory device coupled to said vision microprocessor,
a persistent memory device coupled to said vision microprocessor, wherein said persistent memory device is a non-volatile storage device,
means connected to said vision microprocessor for triggering a permanent storage in response to selective triggering events, in said persistent memory device, of a plurality of consecutive frames of captured visual scene, wherein said permanent storage of a plurality of consecutive frames is achieved by means of prohibiting the current content in said persistent memory from being over-written by new images after a pre-programmed elapsed time period such that said plurality of consecutive frames stored are composed of a number of images captured so many seconds before and after said selective triggering events occur, wherein the number of said images stored is a function of the size of said persistent memory, wherein said persistent memory consisting of a finite number of storage elements overwritten repeatedly by said vision microprocessor in a first-in-first-out fashion so that a finite storage can be used to buffer up a plurality of said images continuously,
means connected to said vision microprocessor for manually triggering the said permanent storage, in said persistent memory device, of frames of said visual scene, wherein said manually triggering can be an action selected from the group consisting of taking snap shots of visual scene, taking a sequence of continuous images of visual scene, taking a sequence of continuous images of visual scene that makes up so many seconds before and after said trigger and freezing the activity of said continuously capturing visual information so as to prevent existing said images in said persistent memory of being replaced by new images in order to preserve existing said images,
wherein said stored frames can be used for various purposes, including accident aftermath analysis and documentation of the visual aspects of an event or scene; and
said microprocessor executing software being adaptable to learn and store a plurality of events including hazardous events and inconsequential events, said microprocessor being operative to alert operator in response to identifying the hazardous events by inspecting said captured real-time images.

2. A digital in-vehicle device as recited in claim 1 further comprises a mounting assembly for mounting said in-vehicle device so as to allow said device to be securely and steadily positioned, while at the same time causing minimum interference with the vehicle operator's field of view, said mounting assembly providing for a mounting arrangement chosen from the group consisting of mounting said device behind the vehicle's rearview mirror and mounting said devices as an integral part of the vehicle's rearview mirror.

3. A digital in-vehicle device as recited in claim 1 further comprising
a computational microprocessor;
a computational memory and storage device coupled to said computational microprocessor and
a communications unit.

4. A digital in-vehicle device as recited in claim 3 further comprising a mounting assembly for mounting said in-vehicle device so as to allow said devices and said units to be securely and steadily positioned, while at the same time causing minimum interference with the vehicle operator's field of view, said assembly providing for a mounting arrangement chosen from the group consisting of mounting said devices and said units behind the vehicle's rearview mirror and mounting said device as an integral part of the vehicle's rearview mirror.

5. A digital in-vehicle device as recited in claim 3, wherein said computational and vision microprocessors are merged into the same microprocessor and said computational and vision memory devices are merged into the same memory device.

6. A digital in-vehicle device as recited in claim 3, wherein said communications unit comprises:
a data input and output port connected to said computational unit that receives data from and communicates data to an external computer,
a global position system (GPS) antenna and receiver that are connected to said computational unit for receiving signals from GPS satellites, wherein said computational unit further comprises the means for processing said GPS signals to help determine the current position of said vehicle, and
means for providing communications from said computational unit to a vehicle operator, said means connected to said computational unit and chosen from the group consisting of a directional indicator screen that displays icons which provide navigational information in a visual form, and a voice input-output system, which is connected to said computational unit, that converts a vehicle operator's spoken message into digital information for input into said computational unit, while also using portions of the computational unit's digital output to provide the vehicle operator with navigational information in an audible form.

7. A digital in-vehicle device as recited in claim 6, wherein said antenna and receiver are portable and located inside a vehicle exposed to the sky through the windshield such that said antenna and receiver can be readily used for most vehicles without any special or deliberate arrangement.

8. A digital in-vehicle device as recited in claim 2, wherein, for a vehicle having a rearview mirror with a mirror attached to the front surface of a frame and from the rear side of said frame extends a mounting arm that holds the frame in a desired position and connects the frame to an interior surface of said vehicle, comprising a mounting assembly for mounting said devices behind said vehicle's rearview mirror comprises:
a case having a box-shape with inner and outer surfaces, including outer front and top surfaces, said devices being operationally connected to said inner surfaces so that the case forms a protective enclosure for said devices, said case so configured and of a size so that, when the front surface of said case is in close proximity to the rear surface of said rearview mirror frame, the vehicle operator's field of view is not obstructed, and said outer top surface of said case having a recessed portion that accommodates the rearview mirror frame's mounting arm while allowing the said front outer surface of said case to be placed in close proximity to the rear surface of said rearview mirror frame,
a ball joint attached to said case's outer top surface,
an extendible pole having a top end and a bottom end, said bottom end being attached to said ball joint, said pole having a plurality of tubular members that are retractably enmeshed with each other,
a clamp having a clamp base, a pair of clamping jaws attached to said clamp base, and means coupled to said clamping jaws for biasing said clamping jaws towards one another so that they releasably affix said clamp to said rearview mirror frame mounting arm, and
a hinge that couples said clamp base with the top end of said extendible pole.

9. A digital in-vehicle device as recited in claim 4 wherein, for a vehicle having a rearview mirror with a mirror attached to the front surface of a frame and from the rear side of said frame extends a mounting arm that holds the frame in a desired position and connects the frame to an interior surface of said vehicle, comprising a mounting assembly for mounting said devices and said units behind said vehicle's rearview mirror comprises:
a case having a box-shape with inner and outer surfaces, including outer front and top surfaces, said devices and said units being operationally connected to said inner surfaces so that the case forms a protective enclosure for said devices and said units, said case so configured and of a size so that, when the front surface of said case is in close proximity to the rear surface of said rearview mirror frame, the vehicle operator's field of view is not obstructed, and said outer top surface of said case having a recessed portion that accommodates the rearview mirror frame's mounting arm while allowing the said front outer surface of said case to be placed in close proximity to the rear surface of said rearview mirror frame,
a ball joint attached to said case's outer top surface,
an extendible pole having a top end and a bottom end, said bottom end being attached to said ball joint, said pole having a plurality of tubular members that are retractably emeshed with each other,
a clamp having a clamp base, a pair of clamping jaws attached to said clamp base, and means coupled to said clamping jaws for biasing said clamping jaws towards one another so that they releasably affix said clamp to said rearview mirror frame mounting arm, and
a hinge that couples said clamp base with the top end of said extendible pole.

10. A digital in-vehicle device as recited in claim 2, wherein said mounting assembly for mounting said devices as an integral part of the vehicle's rearview mirror comprises:
a case having a box-shape with inner and outer surfaces, including outer front, back and side surfaces, said devices being operationally connected to said inner surfaces so that the case forms a protective enclosure for said devices,
wherein said vehicle having a rearview mirror assembly that is especially configured to mesh with said case, said rearview mirror assembly comprising a frame having a pair of leg portions horizontally spaced apart from one another and connected by a middle portion, which has a front, rear and top surface, said middle portion extending between and connected to said leg portions so as to define a slot in said frame for receiving and supporting the sides of said case therein between said leg portions and the rear surface of said middle portion,
wherein said rearview mirror assembly further comprising a mirror attached to the front surface of the middle portion of said frame, a mounting arm having a top and bottom end, the bottom end being attached to the top surface of said middle portion, the arm holding the frame in a desired position with top end of said arm connected to an interior surface of said vehicle.

11. A digital in-vehicle device as recited in claim 4, wherein said mounting assembly mounting said devices and said units as an integral part of the vehicle's rearview mirror comprises:
a case having a box-shape with inner and outer surfaces, including outer front, back and side surfaces, said devices and said units being operationally connected to said inner surfaces so that the case forms a protective enclosure for said devices and said units,
wherein said vehicle having a rearview mirror assembly that is especially configured to mesh with said case, said rearview mirror assembly comprising a frame having a pair of leg portions horizontally spaced apart from one another and connected by a middle portion, which has a front, rear and top surface, said middle portion extending between and connected to said leg portions so as to define a slot in said frame for receiving and supporting the sides of said case therein between said leg portions and the rear surface of said middle portion,
wherein said rearview mirror assembly further comprising a mirror attached to the front surface of the middle portion of said frame, a mounting arm having a top and bottom end, the bottom end being attached to the top surface of said middle portion, the arm holding the frame in a desired position with top end of said arm connected to an interior surface of said vehicle.

12. A digital in-vehicle device as recited in claim 1, wherein said
means connected to said vision microprocessor for triggering the automatic storage including a variety of mechanisms chosen from the group consisting of programmable logical instructions resided inside said vision memory that fire off signals to said vision microprocessor in responding to said actual scene captured, hardware mechanisms and combinations thereof, wherein said hardware mechanism including at least one sensor capable of sending out a signal to said vision microprocessor upon detecting a physical event, wherein said physical event can be a physical impact, sudden change in momentum, sudden change in sound wave amplitude and combinations thereof.

13. A digital in-vehicle device as recited in claim 1, wherein said means connected to said vision microprocessor for manually triggering the storage in said persistent memory device of detected visual information including at least one mechanism capable of causing a signal to be sent to said vision microprocessor, wherein said mechanism is selected from the group consisting of push button, flip switch and voice input unit.

14. A method for digitally capturing an actual scene so that captured images can be used for various purposes, said method comprising the steps of:
continuously capturing actual scene in real-time and converting said scene into digital form,
permanently storing up captured said images so that said images can be retrieved for viewing at a later time,
continuously buffering up a plurality of captured images using a first-in-first-out mechanism so that said buffered images can be preserved permanently if so desired,
manually triggering the storage in a persistent memory device of consecutive frames of detected visual information, wherein said manually triggering can be an action selected from the group consisting of taking snap shots of visual scene, taking a sequence of continuous images of visual scene, taking a sequence of continuous images of visual scene that makes up so many seconds before and after said trigger and freezing the activity of said continuously capturing visual information so as to prevent existing said images in said persistent memory be replaced by new images in order to preserve existing said images.

15. The method as recited in claim 14 further comprising the step of:
comparing captured images with database images and alerting operator of potential hazardous condition.

16. The method as recited in claim 14 further comprising the step of:
inspecting captured images and alerting operator of potential hazardous condition.

17. The method as recited in claim 14 further comprising the step of:
learning to recognize and store hazardous and inconsequential conditions.

18. The method as recited in claim 14 further comprising the step of:
automatically triggering a permanent storage of a plurality of consecutive frames of captured visual information, wherein said permanent storage of a plurality of consecutive frames is achieved by prohibiting older said images from being erased and replaced by newer images after a pre-programmed elapsed time period such that said plurality of consecutive frames stored are composed of a number of images captured so many seconds before and after said automatic triggering,

19. The method as recited in claim 14 further comprising the step of:
analyzing said images to extract information in real-time useful for navigation assistance and accident avoidance purpose.

20. The method as recited in claim 14 further comprising the step of:
receiving global positioning system (GPS) signals for travel direction and position assistance.

21. The method as recited in claim 19 further comprising the step of:
providing directional information to said operator in a manner which does not distract said operator from more important concurrent task, wherein said direction indication is in the form of display symbol within the field of view of said operator.

22. The method as recited in claim 20 further comprising the step of:
providing directional information to said operator in a manner which does not distract said operator from more important concurrent task, wherein said direction indication is in the form of display symbol within the field of view of said operator.

23. The method as recited in claim 14 further comprising the steps of:
providing information to said operator in an audible form, and receiving verbal command from said operator and converting said command into digital form.

24. The method as recited in claim 18 further comprising the step of:
detecting external events including physical impact, sudden change of momentum, sudden change of sound amplitude, and unusual occurrence or movement of objects in said visual scene captured so as to generate said automatic triggering.

25. A method for digitally capturing an actual scene so that captured images can be used for various purposes, said method comprising the steps of:
continuously capturing actual scene in real-time and converting said scene into digital form, controlling the operation and timing of said capture process,
permanently storing up captured said images so that said images can be retrieved for viewing at a later time,
continuously buffering up a plurality of captured images using a first-in-first-out mechanism so that said buffered images can be preserved permanently if so desired,
inspecting captured images and alerting operator of potential hazardous condition,
manually triggering the storage in a persistent memory device of consecutive frames of detected visual information, wherein said manually triggering can be an action selected from the group consisting of taking snap shots of visual scene, taking a sequence of continuous images of visual scene, taking a sequence of continuous images of visual scene that makes up so many seconds before and after said trigger and freezing the activity of said continuously capturing visual information so as to prevent existing said images in said persistent memory be replaced by new images in order to preserve existing said images.

26. A method for digitally capturing an actual scene so that captured images can be used for various purposes, said method comprising the steps of:
continuously capturing actual scene in real-time and converting said scene into digital form, controlling the operation and timing of said capture process,
continuously buffering up a plurality of captured images using a first-in-first-out mechanism so that said buffered images can be preserved permanently if so desired,
inspecting captured images and alerting operator of potential hazardous condition,
manually triggering the storage in a persistent memory device of consecutive frames of detected visual information, wherein said manually triggering can be an action selected from the group consisting of taking snap shots of visual scene, taking a sequence of continuous images of visual scene, and freezing the activity of said continuously capturing visual information so as to prevent existing said images in said persistent memory be replaced by new images in order to preserve existing said images.

27. A method for digitally capturing an actual scene so that captured images can be used for various purposes, said method comprising the steps of:
continuously capturing actual scene in real-time and converting said scene into digital form, p1 continuously buffering up a plurality of captured images using a first-in-first-out mechanism so that said buffered images can be preserved permanently if so desired,
manually triggering the storage in a persistent memory device of consecutive frames of detected visual information, wherein said manually triggering can be an action selected from the group consisting of taking snap shots of visual scene, taking a sequence of continuous images of visual scene, taking a sequence of continuous images of visual scene that makes up so many seconds before and after the trigger and freezing the activity of said continuously capturing visual information so as to prevent existing said images in said persistent memory be replaced by new images in order to preserve existing said images.

28. A method for digitally capturing an actual scene so that captured images can be used for various purposes, said method comprising the steps of:
continuously capturing actual scene in real-time and converting said scene into digital form,
continuously buffering up a plurality of captured images using a first-in-first-out mechanism so that said buffered images can be preserved permanently if so desired,
inspecting captured images and alerting operator of potential hazardous condition,
automatically triggering a permanent storage of a plurality of consecutive frames of captured visual information, wherein said permanent storage of a plurality of consecutive frames is achieved by prohibiting older said images from being erased and replaced by newer images after a pre-programmed elapsed time period such that said plurality of consecutive frames stored are composed of a number of images captured so many seconds before and after said automatic triggering.
